(19) United States
(12) Patent Application Publication
(10) Pub. No.: US 2007/0154682 A1
(43) Pub. Date: Jul. 5, 2007

(54) MOLDED SOUND ABSORBER WITH INCREASED SURFACE AREA

(75) Inventors: Terence Connelly, Plymouth, MI (US); Edward Simon, Canton, MI (US); Ka Hing Fung (Kent), Windsor, ON (CA)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/275,380

(22) Filed: Dec. 29, 2005

(51) Int. Cl. B32B 3/30

(52) U.S. Cl. 428/167; 428/172; 428/158

(57) ABSTRACT

A sound absorber includes a molded sheet having a first side and a second side. The first side of the molded sheet is substantially non-planar while the second side is such that the molded sheet can be placed proximate to an automobile component surface with the second surface adjacent to or opposing the automobile component surface. The first side has a surface area that is greater than an equivalent surface area of a planar surface. A method of forming the sound absorber includes compression molding of thermosetting materials.

### BACKGROUND OF THE INVENTION

1 Field of the Invention

The present invention relates to sound absorbing components that are useful in reducing sound perception in automotive applications.

2. Background Art

There is an increasing demand for the reduction of sound levels to improve speech perception in passenger compartments of automobiles. Development of methods and systems that accomplish such reductions require an understanding of the potential internal and external noise sources in an automobile as well as the effect of various automobile components in masking or attenuating such noise. Moreover, reduction of noise in the 1 KHz to 5 KHz frequency range is particularly desirable due to the increased sensitivity of vehicle passengers in that range for speech intelligibility and speech clarity.

Concurrent with these sound reduction demands, economic factors provide pressure to reduce the weight of all automobile components including sound absorbing components. Lighter weight components lower the cost of manufacturing by reducing the amount of materials used, and generally lower the operating expense of the vehicle by contributing toward improving the gas mileage. On the other hand, the benefits of lighter weight sound absorbing components must be balanced with a competing issue of strength. For example, if a sound absorbing pad is too thin, it may not be sufficiently rigid to be positioned without extra support.

The attenuation of sound waves present in automobile passenger compartments is accomplished by a number of components. For example, dash and floor panels have been designed to include sound absorbing or attenuating material. However, success using sound attenuating dash and floor panels have been limited by material properties and design restraints. Moreover, incorporation of complicated sound absorbing systems and components into an automobile are undesirable because of the additional cost of such systems and the added burden of incorporation in an aesthetically pleasing manner.

Accordingly, their exists a need in the prior art for more economical and efficient systems for reducing noise in an automobile.

### SUMMARY OF THE INVENTION

The present invention solves one or more problems of the prior art by providing in at least one embodiment a sound absorber suitable in automotive applications. The sound absorber of the present invention comprises a molded sheet having a first side and a second side. The first side of the molded sheet is substantially non-planar while the second side is such that the molded sheet can be placed proximate to an automobile component surface with the second surface adjacent to or opposing the automobile component surface. In order to absorb sound efficiently, the first side has a surface area that is greater than an equivalent surface area of a planar surface. Advantageously, the sound absorber of the invention is useful for sound insulation in a vehicle engine compartment. An example of the position at which the sound absorber of the invention can be placed include, under the vehicle hood, along the fire wall, around the shock tower, and the like.

In another embodiment of the present invention, a method of molding the sound absorber described above is provided. The method of this embodiment comprises introducing a molding material into a mold cavity. The molding cavity has a surface that is the inverse of the first surface. Next, sufficient heat or pressure to form the sound absorber is applied.

### BRIEF DESCRIPTION OF THE DRAWINGS

FIG. 1A is a perspective view of a sawtooth variation of the present invention;

FIGURE 1B is a side view of a sawtooth variation of the present invention;

FIG. 2 plots the random incidence sound absorption versus the sound frequency for a flat sample, a sawtooth sample with a 90 degree interior angle, and a 60 degree interior angle;

FIG. 3A is a perspective view of a curved variation of the present invention;

FIG. 3B is a side view of a curved variation of the present invention; and

FIG. 4 plots the random incidence sound absorption versus the sound frequency for a flat sample.

### DETAILED DESCRIPTION OF THE PREFERRED EMBODIMENT(S)

Reference will now be made in detail to presently preferred compositions or embodiments and methods of the invention, which constitute the best modes of practicing the invention presently known to the inventors.

In an embodiment of the present invention, a sound absorber suitable for providing sound insulation in automotive applications is provided. The sound absorber of the present invention comprises a molded sheet having a first side and a second side. The first side of the molded sheet is substantially non-planar while the second side is such that the molded sheet can be placed proximate to an automobile component surface with the second surface adjacent to or opposing the automobile component surface. In order to absorb sound efficiently, the first side has a surface area that is greater than an equivalent surface area of a planar surface. This greater surface area is achieved by the first side having corrugations. In one variation, the first side comprises corrugations along a single direction. In another variation, the first side has corrugations along two distinct directions. In a variation, the higher surface area is obtained constructing the molded sheet to have a cross section that is at least partially curved. In another variation of the present embodiment, the first side has a surface area that is from about 1.1 to about 4 times greater then a corresponding planar surface. In yet another variation, the first side has a surface area that is from about 1.2 to about 3.0 times greater then a corresponding planar surface. In still another variation, the first side has a surface area that is from about 1.3 to about 2.0 times greater then a corresponding planar surface. The first side of the present embodiment includes virtually any shape that is non-planar. For example, the first surface may have a substantially egg-crate pattern having a plurality of peaks and valleys (corrugations in two directions), a sawtooth pattern, or a curved pattern. Optionally, the sound absorber further comprises a scrim layer over the first side. Typically, such a scrim layer is for aesthetic purposes having less air flow resistance than the molded sheet.

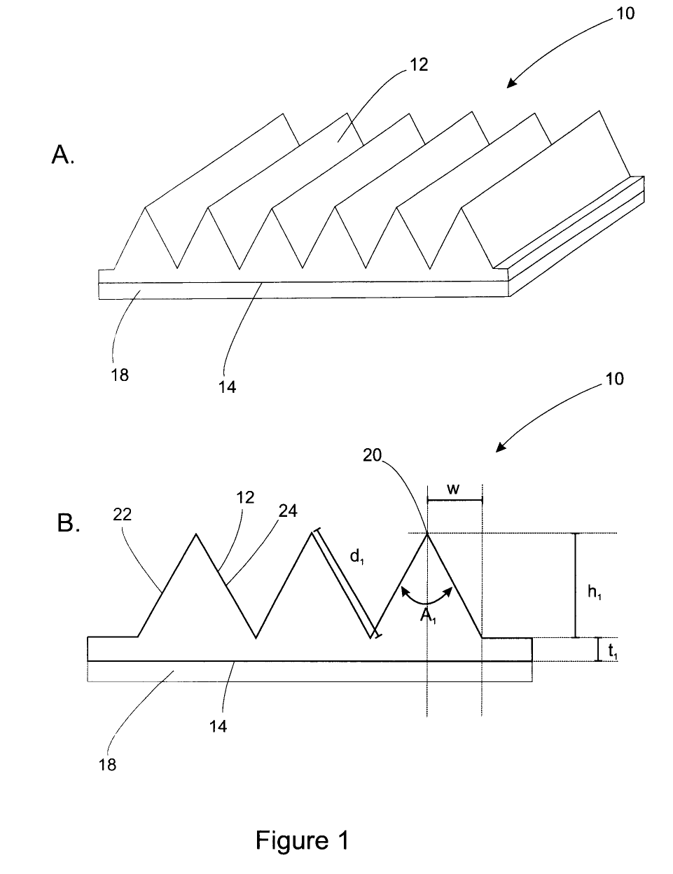

With reference to FIGS. 1A and 1B, views of various sound absorbers of the present embodiment are provided. FIG. 1A provides a perspective view while FIG. 1B provides a cross-sectional view of a variation in which the first side of molding sheet has a sawtooth configuration. Moldable sheet 10 includes first side 12 and second side 14. Second side 14 opposes automobile component surface 18 and is substantially planar. Substantially planar in this context means that the surface area is approximately equal to the area of a flat surface of the same dimensions. It should be appreciated that second side 14 need not be flat since it may bend to conform to automobile component surface 18. In FIGS. 1A and 1B, first side 12 is shown to have a substantially sawtooth cross section that is defined by interior angle A₁ at a peak position 20. Angle A₁ is defined by first sawtooth side 22 and a second sawtooth side 24 each having sawtooth length d₁, sawtooth height h₁, and sawtooth width w. In a refinement of the present variation, interior angle A₁ is from about 30 to about 120 degrees, height h is from about 12 to about 76 mm and the width is from about 3 to about 28 mm. Molded sheet 10 also includes base section 30 which is characterized by thickness t₁. Typically, t₁ is from about 2 mm to about 28 mm. In another variation, t₁ is from about 2 mm to about 20 mm. Moreover, t₁ may not be constant throughout molded sheet 10.

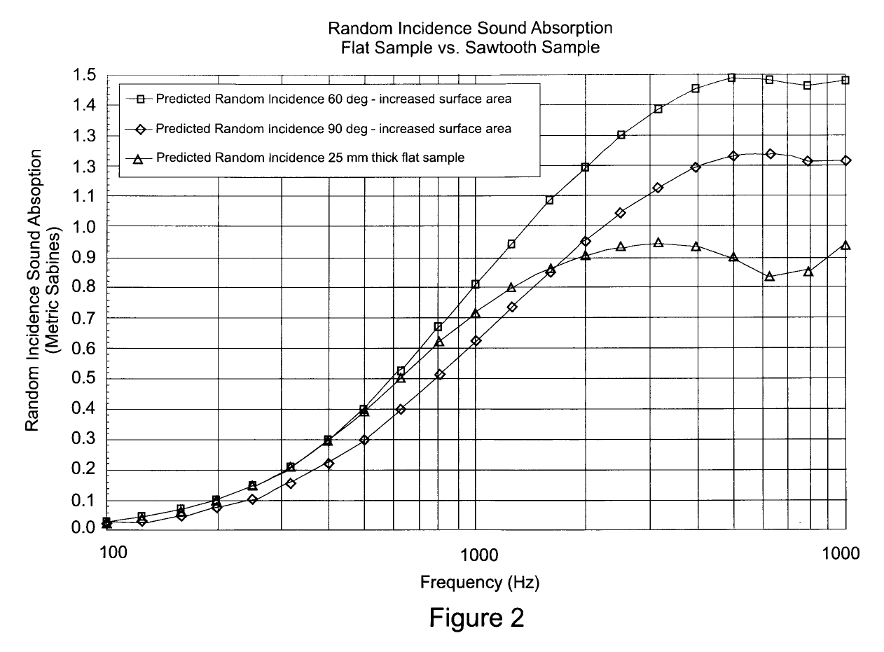

Table 1 provides combinations of parameters for the sawtooth variation. In general, more acute values of the interior angle A₁ for a given height provide a greater increase in surface area than for less acute angles. FIG. 2 provides plots of the random incidence sound absorption versus the sound frequency for a flat sample, a sawtooth sample with a 90 degree interior angle, and a 60 degree interior angle. Both of the sawtooth configurations exhibited higher sound absoption in the sound frequency range of 2000 to 10,000 Hz.

TABLE 1
Parameters for a sawtooth molded sheet.

| | A₁ (degrees) | | | | | | | | | |
|---|---|---|---|---|---|---|---|---|---|---|
| | 30 | 40 | 50 | 60 | 70 | 80 | 90 | 100 | 110 | 120 |
| h₂ (m) | 0.022 | 0.022 | 0.022 | 0.022 | 0.022 | 0.022 | 0.022 | 0.022 | 0.022 | 0.022 |
| d₁ (m) | 0.023 | 0.023 | 0.024 | 0.025 | 0.027 | 0.029 | 0.031 | 0.034 | 0.038 | 0.044 |
| w (m) | 0.006 | 0.008 | 0.010 | 0.013 | 0.015 | 0.018 | 0.022 | 0.026 | 0.031 | 0.038 |
| surface area | 286.4 | 192.4 | 136.6 | 100.0 | 74.3 | 55.6 | 41.4 | 30.5 | 22.1 | 15.5 |
| increase | | | | | | | | | | |

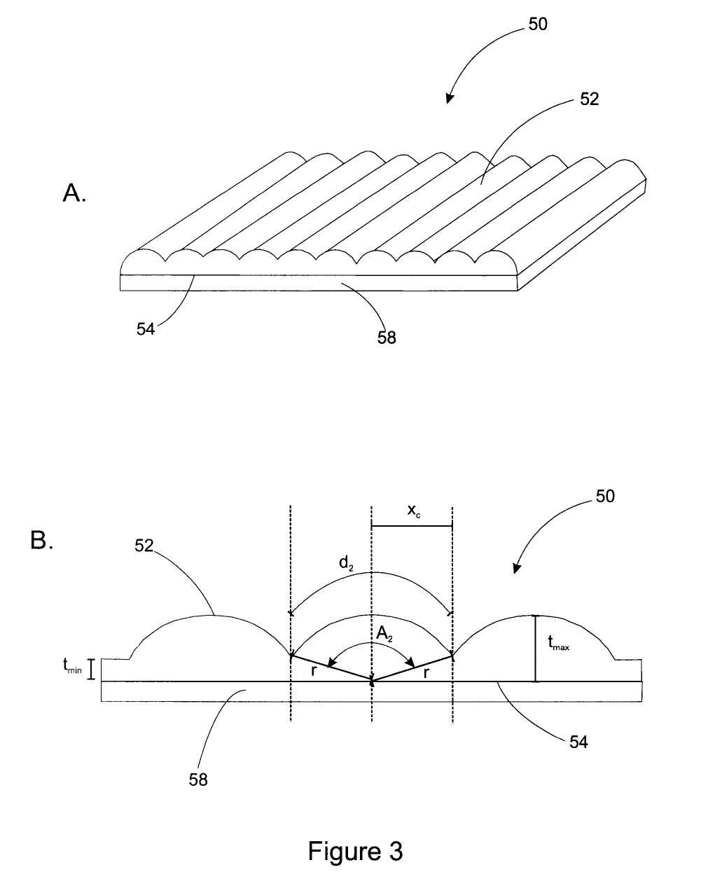

FIGS. 3A and 3B provide views of a variation of the present invention in which the molded sheet has a curved section with a semi-circular cross section. FIG. 2A provides a perspective view while FIG. 2B provides a cross-sectional view of this variation. Molded sheet 50 includes first side 52 and second side 54. Second side 54 opposes automobile component surface 58 and is substantially planar. In FIGS. 2A and 2B, first side 52 is shown to have curved section 60 which is semi-circular having an arc 62 having an arc length d₂ which is defined by radius r, and arc angle A₂. In a refinement of the present variaiton, arc angle A₂ is from about 90 to about 180 degrees. In another refinement, arc length d₂ from about 20 mm to about 100 mm. Molded sheet 50 also includes base section 64 which is continuous with curved section 60. Base section 64 is characterized by having a thickness tₘᵢₙ. Typically, thickness tₘᵢₙ is from about 2 mm to about 28 mm. In another variation, tₘᵢₙ is from about 2 mm to about 20 mm. Moreover, tₘᵢₙ may not be constant throughout molded sheet 50. Thickness tₘₐₓ is the distance from the bottom of base section 64 and the top of curved section 60. Typically, tmas is from about 3 mm to about 25.

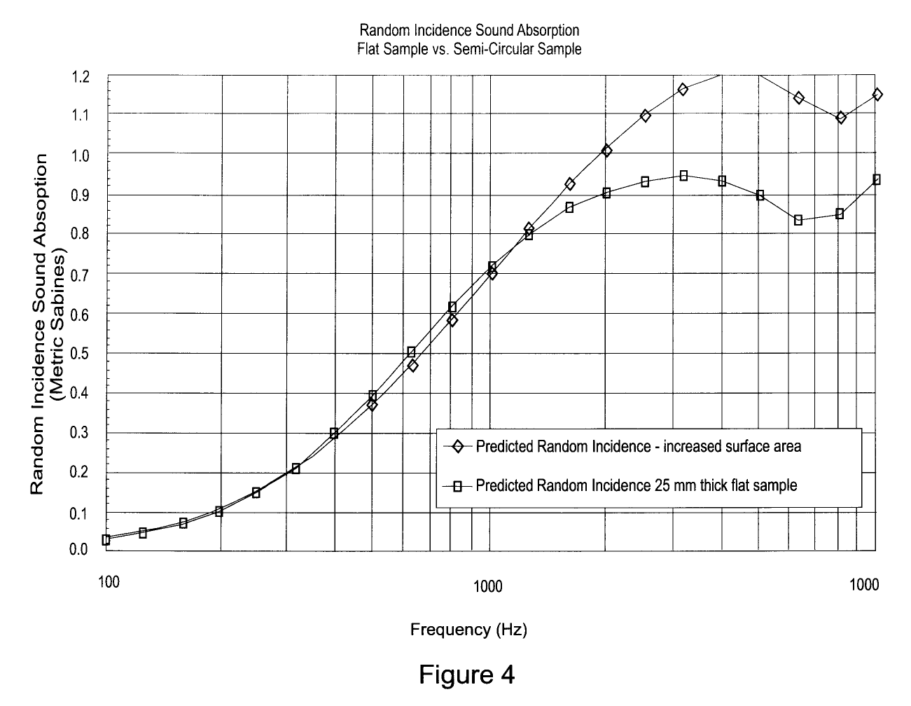

Table 2 provides combinations of parameters for the semi-circular variation. In general, more acute values of the arc angle A₂ for a given height provide a greater increase in surface area than for less acute angles. FIG. 4 provides plots of the random incidence sound absorption versus the sound frequency for a flat sample and for a sample with a semicircular sample. Again, the sound absorption of the sample with the higher surface area (i.e., the semicirular sample) is greater.

TABLE 2
Parameters for a semi-circular sheet having a radius r of 0.025 m.

| | A₂ (degrees) | | | | | | | |
|---|---|---|---|---|---|---|---|---|
| | 90 | 120 | 130 | 140 | 150 | 160 | 170 | 180 |
| X_{c} (m) | 0.018 | 0.022 | 0.023 | 0.024 | 0.024 | 0.025 | 0.025 | 0.02 |
| d₂ (m) | 0.039 | 0.052 | 0.057 | 0.061 | 0.065 | 0.070 | 0.074 | 0.079 |
| 2r | 0.05 | 0.05 | 0.05 | 0.05 | 0.05 | 0.05 | 0.05 | 0.05 |
| Surface | 11.1 | 20.9 | 25.1 | 29.9 | 35.4 | 41.5 | 48.5 | 56.4 |
| area % | | | | | | | | |
| increase | | | | | | | | |

In addition to providing sound absorption when applied to automobile component surfaces, variations of the sound absorber of the prevention invention allows lower density materials to be used for the molded sheet. The corrugations, peaks, and valleys that characterize the present embodiment provide rigidity allowing thinner and less dense materials to be used to form the molded sheet. For example, in a variation of the invention, the molded sheet has a density of about 20 to about 150 grams per square foot. Although any moldable material may be used to form the molded sheet of the invention, thermoplastic resins or thermosetting resins are particularly useful. Useful resins include polyesters (polyethylene terephthalate) and polyolefins (e.g., polypropylene). Typically, useful materials are also fibrous. Such fibrous components include polyester (e.g., polyethylene terephthalate) and polyolefin (e.g., polypropylene) fibers. In yet another refinement, the molded sheet comprises a foam resin (e.g., melamine foam). Moreover, the molded sheet of the present embodiment optionally further comprises an additive selected from the group consisting of glass fibers, cotton (e.g., cotton shoddy), fire retardants, and combinations thereof.

In another embodiment of the present invention, a method of molding the sound absorber described above by a compression molding process is provided. The method of this embodiment comprises introducing a molding material into a heated mold cavity. The molding cavity has a surface that is the inverse of the first surface. Next, sufficient heat or pressure to cure the molding material is applied thereby forming the sound absorber.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A sound absorber comprising:
a molded sheet having a first side and a second side, the first side being substantially non-planar and the second side placeable adjacent to an automobile component surface wherein the first side has a surface area that is greater than an equivalent surface area of a planar surface.

2. The sound absorber of claim 1 wherein the molded sheet has a cross section that is at least partially curved.

3. The sound absorber of claim 1 wherein the molded sheet has a substantially sawtooth cross section that is defined by an interior angle at a peak position defined by a first sawtooth side and a second sawtooth side, a sawtooth height, and sawtooth width.

4. The sound absorber of claim 3 wherein the interior angle is from about 30 to about 120 degrees.

5. The sound absorber of claim 3 wherein the height is from about 12 to about 76 mm and the width is from about 3 to about 28 mm.

6. The sound absorber of claim 1 wherein the molded sheet has a curved section with a semi-circular cross section defined by an arc length and an arc angle.

7. The sound absorber of claim 6 wherein the molded sheet further comprises a base section upon which the curved section is attached.

8. The sound absorber of claim 6 wherein the arc angle is from about 90 to about 180 degrees.

9. The sound absorber of claim 6 wherein the arc length is from about 20 mm to about 100 mm.

10. The sound absorber of claim 1 wherein the first side has a surface area that is from about 1.1 to about 4 times greater then a corresponding planar surface.

11. The sound absorber of claim 1 wherein the first side comprises corrugations along a single direction or corrugations along two distinct directions.

12. The sound absorber of claim 1 wherein the molded sheet has a density of about 20 to about 150 grams per square foot.

13. The sound absorber of claim 1 wherein the molded sheet comprises a polyester or polyolefin fibrous component.

14. The sound absorber of claim 1 wherein the molded sheet comprises a thermoplastic resin, a thermosetting resin, or a foam resin.

15. The sound absorber of claim 1 wherein the molded sheet comprises polyethylene terephthalate, cotton, glass fibers, melamine foam, and combinations thereof.

16. The sound absorber of claim 1 wherein the molded sheet further comprises an additive selected from the group consisting of glass fibers, cotton, fire retardants, and combinations thereof.

17. A method of molding a sound absorber having a molded sheet having a first side and a second side, the first side being substantially non-planar and the second side placeable adjacent to an automobile component surface wherein the first side has a surface area that is greater than an equivalent surface area of a planar surface, the method comprising:
a) introducing a molding material into a heated mold cavity, the mold cavity having a surface that is the inverse of the first surface; and
b) applying sufficient heat or pressure to form the sound absorber.

18. The method of claim 18 wherein the molded sheet has a cross section that is at least partially curved.

19. The method of claim 18 wherein the molded sheet has a substantially sawtooth cross section that is defined by an interior angle at a peak position defined by a first sawtooth side and a second sawtooth side, a sawtooth height, and sawtooth width.

20. The method of claim 18 wherein the molded sheet comprises a thermoplastic resin, a thermosetting resin, or a foam resin.
